(19) United States
(12) Patent Application Publication
(10) Pub. No.: US 2011/0120966 A1
(43) Pub. Date: May 26, 2011

(54) PORTABLE FOLDING DISPLAY RACK

(75) Inventor: Scott L. Salzstein, Buffalo Grove, IL (US)

(73) Assignee: HANDI-FOIL CORPORATION, Wheeling, IL (US)

(21) Appl. No.: 12/624,624

(22) Filed: Nov. 24, 2009

(51) Int. Cl. A47F 5/00; B60B 33/00

(52) U.S. Cl. 211/149; 16/18 R

(57) ABSTRACT

A portable display rack is provided with a frame having a front side, a rear side, a left side, a right side, a top side, and a bottom side. A plurality of shelves positioned between the left and rights sides and extending from the rear side towards the front side. Each shelf has a width defined such that the front portion extends between first and second vertical posts defined by the front side. The left and right side of the frame is pivotally hinged to the rear side, such that when the shelves are removed, the left and right sides of the frame are capable of being folded along the pivotally hinges against the rear side of the frame.

### FIELD OF THE INVENTION

The present invention relates to merchandise display racks, and more particularly to a portable folding display rack which is easy to assemble and adapted to display products.

### BACKGROUND OF THE INVENTION

Merchandise display racks are used to hold and display a wide variety of products. Often times the display racks will include casters or the like in order to provide the flexibility to move the display racks anywhere in a store. Portable display racks which are provided by a manufacturer are usually adapted for use with a particular type or brand of merchandise. These portable display racks are often pre-assembled or once assembled only capable of being moved by the casters. Thus there is an advantage to having the display rack easily foldable such that the there is little assembly time or if needed can be easily folded and moved to another store or location within a store that is inaccessible or difficult to place because of the casters. In addition, close review of these and other prior art references finds that the shelf or basket are always leveled with or held relatively even with the bracket. Therefore, there is also an advantage to have the display rack assembled with slanted shelving to support the display of specialized goods.

### SUMMARY OF THE INVENTION

In accordance with the present invention there is provided in one embodiment a portable display rack. The display rack is defined by a frame having a front side, a rear side, a left side, a right side, a top side, and a bottom side and a plurality of shelves. The front side of the frame has a first vertical post and a second vertical post separated from the first vertical post by a distance, permitting the front side of the frame to be substantially open. The left and right sides of the frame each have first and second horizontal side posts extending from both ends of the first and second vertical posts towards the rear side of the frame. The rear side of the frame has first and second horizontal rear posts extending along the rear side and being separately connect by pivotally attachments to ends defined by the first and second side posts. The rear side of the frame further has three vertical rear posts connected between the first and second horizontal rear posts. Each of the three vertical rear posts have spaced apart apertures.

The plurality of shelves are positioned between the left and rights sides and extend from the rear side towards the front side of the frame. Each shelf has at least a flat bottom and rear and front portions with an upwardly turned retention end positioned along the front portion. The shelves each further have a width defined such that the front portion extends between the first and second vertical posts defined by the front side of the frame. Each shelf is further angled such that its rear portion is positioned at a higher vertical height then the front portion.

Therefore, when the shelves are removed, the left and right sides of the frame are capable of being folded along the pivotally attachments for positioning against the rear side of the frame.

In other embodiment the rack, the top side of the frame may be defined by having the first horizontal side posts extend about a top portion of the left and right sides of the frame, and wherein the second horizontal side posts extend about a bottom portion of the left and right sides of the frame to further define the bottom side of the frame. In yet other aspects of the invention, the portable display rack may further include a plurality of casters secured to an underside of the bottom side of the frame.

In yet other embodiments, the three vertical rear posts are further defined as a pair of outer posts separated by a distance therebetween and a middle post positioned between the two outer posts. The pair of outer posts being further positioned inwardly along the rear side by a distance from the pivotal attachment.

In yet still other aspects, each of the braces may include an outstanding arm section secured to the flat bottom and an upstanding arm section that has a back side positioned against the rear vertical post and includes a hook extending from the upstanding arm section. The hook being received in the apertures defined along the three vertical rear posts.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a perspective view of one embodiment of the present invention;

FIG. 2 is an enlarged view of section 2 from FIG. 1;

FIG. 3 is a top view of FIG. 1;

FIG. 4 is a side view of FIG. 1; and

FIG. 5 is a perspective view of one embodiment of the present invention, illustrating the display rack without shelving and in a folded position.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

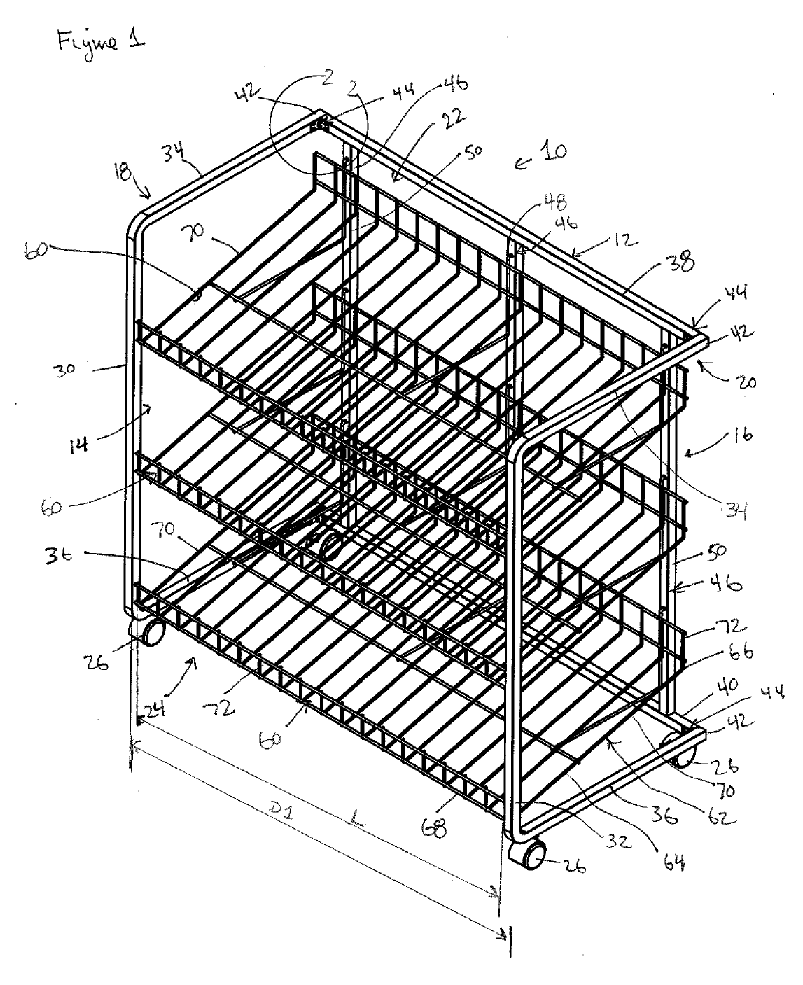

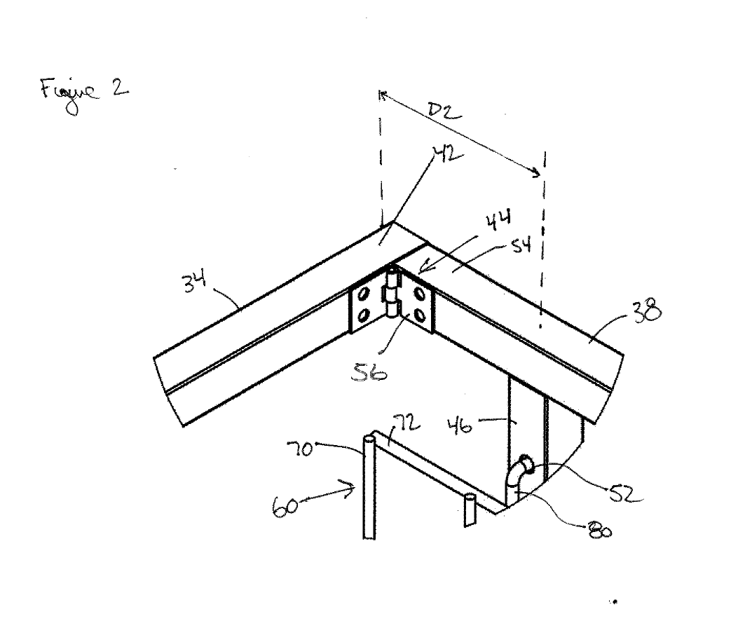

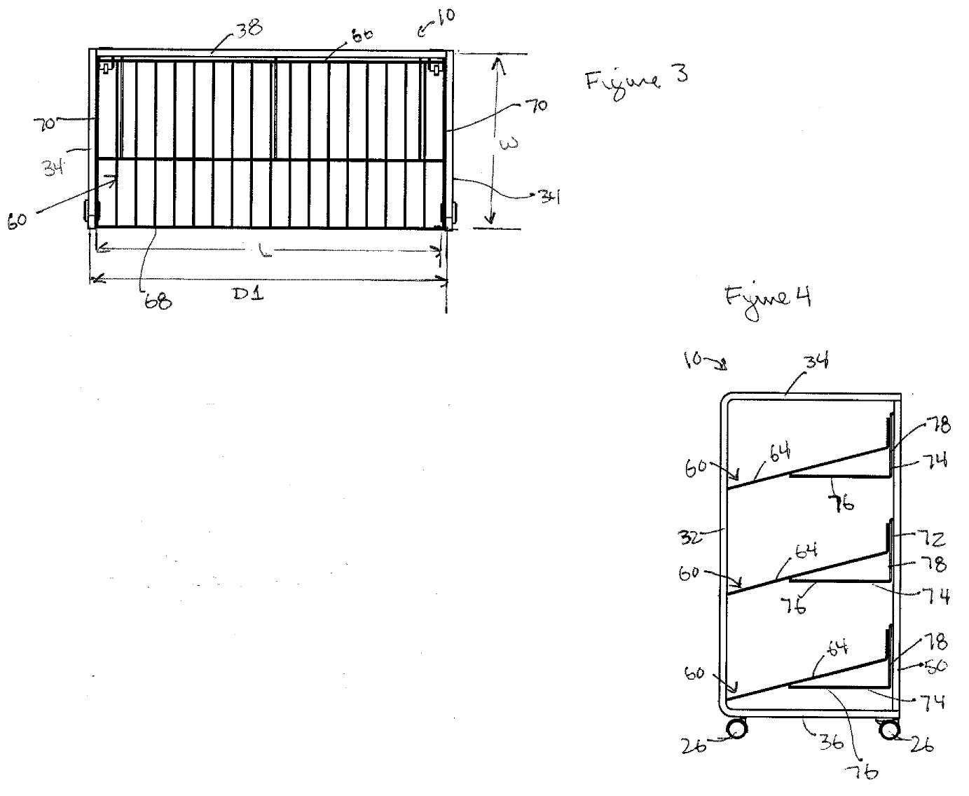

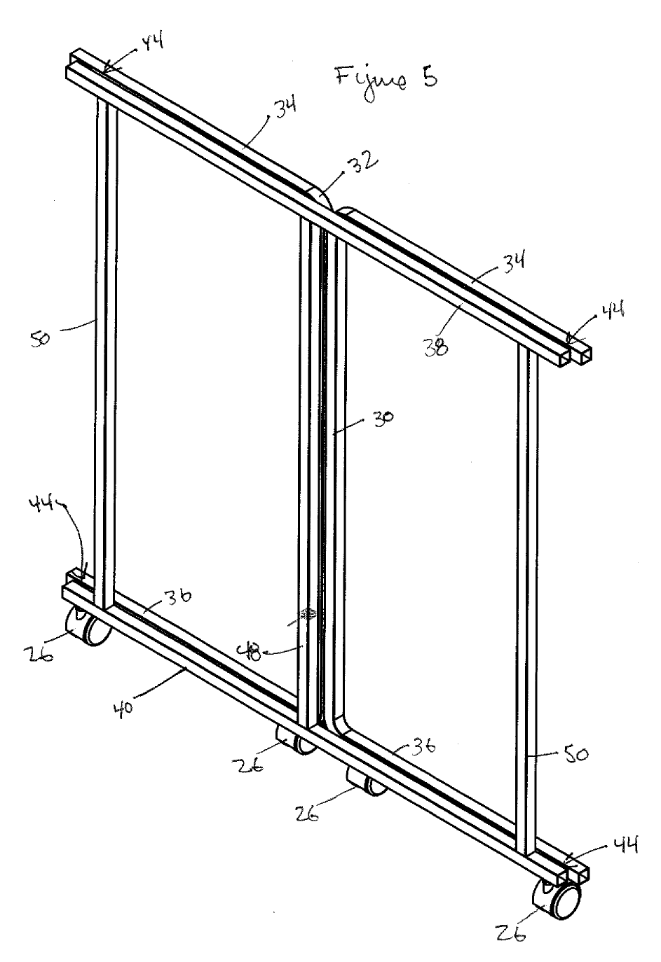

With reference to FIGS. 1-5 there is shown a first embodiment of the display rack 10. The display rack 10 may comprise a frame 12 having a front side 14, a rear side 16, a left side 18, a right side 20, a top side 22, and a bottom side 24. The display rack 10 further comprises a plurality of shelves 60 (discussed in greater detail below). The rack 10 is preferably portable and may comprise a plurality of conventional and commercially available casters 26 which may be equipped with releasable locks or brakes (not shown) to selectively prevent rotation thereof.

The frame 12 may be comprised of a plurality of posts assembled together to form the various sides. The front side 14 may include a pair of vertical posts, namely a first front post 30 and a second front post 32 that are separated from one another by a distance D1. The front side 14 is preferably substantially open so that the merchandise on the shelves 60 is highly visible and accessible to the customers.

Extending horizontally from the ends of the two front posts (30 and 32) towards the rear side 16 of the frame 10 are first and second side posts 34 and 36, respectively. The first side posts 34 extend along the top side 22 of the frame, while the second side posts 36 extend along the bottom side 24 of the frame.

The rear side 16 of the frame 10 includes a pair of horizontal posts, a top rear horizontal post 38 and a bottom rear horizontal post 40. The pair of horizontal posts are pivotally attached 44 at their side ends 54 to the rear ends 42 of the first and second side posts 34 and 36. The pivotally attachment means 44 used to secure the rear ends 42 of the side posts 34, 36 to the side ends 54 of the rear posts 38 and 40 is an inside hinge bracket 56, which permits the right and left sides 16, 18 of the frame 10 to fold into the rear side 16 of the frame.

Three vertical rear posts 46 (a middle rear post 48 and a pair of outer posts 50) extend between the pair of horizontal posts 38 and 40. The pair of outer posts 50 are positioned inwardly along the rear side 16 by a distance D2 from the pivotal attachment 44 of the ends. The inward position of the outer posts 50 help stabilize the assembled frame. Each of the three vertical rear posts 46 include apertures 52 aligned along the same vertical height. The apertures 52 are sized to receive an end of the brace 74 used for the shelf 60 (discussed in further detail below).

Each shelf 60 used on the display rack 10 is formed of a generally U-shaped outer frame 62 inasmuch as the outer frame 62 has a flat bottom 64 with a back portion 66 and a front portion 68 and two side portions 70 to define a width W and length L of the shelf. The back portion 66 and front portion 68 include upwardly turned retention ends 72 to form a retainer for articles positioned on the shelf 60. The outer frame 62 is generally fabricated from relatively heavy gauge wire.

The back portion 66 is at a higher position then the front portion 68 such that the flat bottom 64 is angled. The length L of the shelf between the two side portions 70 is defined to be smaller than the distance D1 defined by the two front posts 30 and 32. In addition, the width W of the shelf between the front and back portions 66 and 68 is defined such that the front portion 68 is positioned between the two front posts 30 and 32. Each shelf is supported by braces 74, preferably three, corresponding to the three rear vertical posts. The braces 74 are L shaped, having an outstanding arm section 76 secured to the bottom of the flat bottom 64, and an upstanding arm section 78 that rests against the rear vertical posts 46. Extending from an end of the upstanding arm section 78 is a flange or hook 80 that inserts into the aperture 52 and which removably secures the shelf 60 to the frame (or to the rear vertical posts).

By removing the shelves 60, the frame 10 can fold and be easily transported or moved. Folding the frame 10 is done at the hinging means 44 permitting the left 18 and right sides 20 of the frame 10 to fold towards and against the rear side 16, shown in FIG. 5.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

We claim:

1. A portable display rack, comprising:
a frame having a front side, a rear side, a left side, a right side, a top side, and a bottom side, wherein:
i) the front side of the frame being defined by a first vertical post and a second vertical post separated from the first vertical post by a distance, permitting said front side of said frame to be substantially open,
ii) the left and right sides of the frame each being defined by first and second horizontal side posts extending from both ends of the first and second vertical posts towards the rear side of the frame,
iii) the rear side of the frame being defined by first and second horizontal rear posts extending along the rear side and being separately connect by pivotally attachments to ends defined by the first and second side posts, the rear side of the frame further defined by having three vertical rear posts connected between the first and second horizontal rear posts, each of the three vertical rear posts having spaced apart apertures;
a plurality of shelves positioned between the left and rights sides and extending from the rear side towards the front side, each shelf, of the plurality of shelves, having at least a flat bottom and rear and front portions with an upwardly turned retention end positioned along the front portion, and further having a width defined such that the front portion extends between the first and second vertical posts defined by the front side, each shelf further being angled such that its rear portion is positioned at a higher vertical height then the front portion; and
each shelf, of the plurality of shelves, includes three braces separately securing the flat bottom of the shelf to the three vertical posts,
whereby, when the shelves are removed, the left and right sides of the frame are capable of being folded along the pivotally attachments for positioning against the rear side of the frame.

2. The portable display rack of claim 1, wherein the first horizontal side posts extend about a top portion of the left and right sides of the frame to further define the top side of the frame, and wherein the second horizontal side posts extend about a bottom portion of the left and right sides of the frame to further define the bottom side of the frame.

3. The portable display rack of claim 2 further comprising a plurality of casters secured to an underside of the bottom side of the frame.

4. The rack display of claim 1, wherein the pivotally attachment is accomplished by having separate folding brackets connecting each end of the first and second horizontal rear posts to ends of the first and second side posts.

5. The rack display of claim 1, wherein the three vertical rear posts is further defined as a pair of outer posts separated by a distance therebetween and a middle post positioned between the two outer posts, the pair of outer posts being further positioned inwardly along the rear side by a distance from the pivotal attachment.

6. The rack display of claim 1, wherein each of the braces include an outstanding arm section secured to the flat bottom and an upstanding arm section that has a back side positioned against the rear vertical post and includes a hook extending from the upstanding arm section, the hook being received in the apertures defined along the three vertical rear posts.

7. The rack display of claim 1, wherein each shelf, of the plurality of shelves further includes an upwardly turned retention end positioned along the back portion.

8. A portable display rack, comprising:
a frame having a front side, a rear side, a left side, a right side, a top side, and a bottom side, wherein:
i) the front side of the frame being defined by a first vertical post and a second vertical post separated from the first vertical post by a distance, permitting said front side of said frame to be substantially open,
ii) the left and right sides of the frame each being defined by first and second horizontal side posts extending from both ends of the first and second vertical posts towards the rear side of the frame,
iii) the rear side of the frame being defined by first and second horizontal rear posts extending along the rear side and being separately connect by pivotally attachments to ends defined by the first and second side posts, the rear side of the frame further defined by having three vertical rear posts connected between the first and second horizontal rear posts, each of the three vertical rear posts having spaced apart apertures, and
wherein the three vertical rear posts is further defined as a pair of outer posts separated by a distance therebetween and a middle post positioned between the two outer posts, the pair of outer posts being further positioned inwardly along the rear side by a distance from the pivotal attachment;
a plurality of shelves positioned between the left and rights sides and extending from the rear side towards the front side, each shelf, of the plurality of shelves, having at least a flat bottom and rear and front portions with an upwardly turned retention end positioned along the front portion, and further having a width defined such that the front portion extends between the first and second vertical posts defined by the front side, each shelf further being angled such that its rear portion is positioned at a higher vertical height then the front portion, each shelf, of the plurality of shelves further includes an upwardly turned retention end positioned along the back portion; and
each shelf, of the plurality of shelves, includes three braces separately securing the flat bottom of the shelf to the three vertical posts,
whereby, when the shelves are removed, the left and right sides of the frame are capable of being folded along the pivotally attachments for positioning against the rear side of the frame.

9. The portable display rack of claim 8, wherein the first horizontal side posts extend about a top portion of the left and right sides of the frame to further define the top side of the frame, and wherein the second horizontal side posts extend about a bottom portion of the left and right sides of the frame to further define the bottom side of the frame.

10. The portable display rack of claim 9 further comprising a plurality of casters secured to an underside of the bottom side of the frame.

11. The rack display of claim 8, wherein the pivotally attachment is accomplished by having separate folding brackets connecting each end of the first and second horizontal rear posts to ends of the first and second side posts.

12. The rack display of claim 8, wherein each of the braces include an outstanding arm section secured to the flat bottom and an upstanding arm section that has a back side positioned against the rear vertical post and includes a hook extending from the upstanding arm section, the hook being received in the apertures defined along the three vertical rear posts.
